(19) United States
(12) Patent Application Publication
(10) Pub. No.: US 2003/0021080 A1
(43) Pub. Date: Jan. 30, 2003

(54) Method and system for simplifying wiring in a modular communications gateway

(76) Inventors: Frank Koperda, Suwanee, GA (US); David D. Lin, San Jose, CA (US); Jeff Zalewski, Novato, CA (US); Jason Hsieh, Hsinchu (TW)

Correspondence Address: GREGORY SMITH & ASSOCIATES, 3900 NEWPARK MALL ROAD, 3RD FLOOR, NEWARK, CA, 94560, US

(21) Appl. No.: 09/944,451

(22) Filed: Aug. 30, 2001

Related U.S. Application Data
(60) Provisional application No. 60/304,546, filed on Jul. 10, 2001.

(51) Int. Cl. H02B 1/00

(52) U.S. Cl. 361/600

(57) ABSTRACT

The invention simplifies the wiring changes needed in a modular communications device as new modules are added to a system and it reduces the initial cost of the base unit. When a module, which contains an additional communications function is added to an existing system, it often becomes necessary to move a communications cable from the existing unit to the new module that has been added. This invention avoids the need of such a cable change, and reduces the costs of having connectors on the new module, and provides scaleable costs that are incurred only as modules are required.

### FIELD OF THE INVENTION

The present invention relates generally to systems for facilitating communications among a variety of communications components in a variety of data/voice communications networks. More specifically, the invention relates to a scalable modular network system that may include many kinds of voice and data components.

### BACKGROUND OF THE INVENTION

Purchasers of network communications equipment typically desire that the system be easily expandable as additional functions or features are needed. Thus, the expandability of a communications network system is an important characteristic of any network system. Communications equipment manufacturers have taken several approaches in balancing the cost, flexibility, and complexity of communications network packaging options. Common solutions include:

a. Providing fixed, relatively non-expandable, functions in a single unit that contains many of the key network functions. This approach optimizes the initial cost of the unit since no extra connectors or over-capacity power supply is needed. However, after the user exceeds the unit's capabilities, the user may need to buy another more robust unit to replace the current unit.

b. Providing independent modular units that plug to each other. This approach allows the communications to be expanded as additional functionality is required. The initial investment is preserved as the new functionality is built into the new modular unit. However, this approach requires a customer to disconnect the old units, add cables to connect the new units, and then reconnect the old units. In a network including many elements, possibly spread over several locations, the process can be overwhelming, especially to individuals who are not technically trained, such as home network consumers.

c. Making a modular unit that has the number and type of connectors fixed on the base unit. This approach normally implies that there is communications switching function in the base system. The base switching function is used to reroute internal communications paths as new communications features are added through new modules. One disadvantage to this system is that the initial, or base unit, must include relatively expensive communications switching functions which may never be required if the system is not expanded beyond its initial configuration.

A practical example of the usefulness of this invention would be in a home environment when a customer buys a cable modem or an ADSL modem. Over time the customer may add additional computers or require additional network control features such as a router or firewall. In such cases, the customer must find a location for the additional component somewhere near the modem. Frequently, the customer must also ensure access to a power-outlet to power the new device. Then the customer disconnects the cable between the computer and modem, connects the modem to the input of the router, and connects the computer to the output of the router.

Prior art for modular systems that do not require the customer to disconnect cables exists but these systems have internal switching functions implemented in the base unit. The cost of base systems will typically be higher than other systems because the base unit cost includes the necessary hardware and/or software of the data combining function necessary to support future modules. For example, if a base unit can accept seven modules, it may need a combiner capable of multiplexing data from seven ports and the cost of the base unit reflects this maximum capacity even if the customer will only use a limited subset of the seven modules.

What is needed is a new communications packaging solution which offers a novel method of adding communications functions to a system while reducing or eliminating the need for a customer to move communications cables and which does not require the base unit to incur the cost of including the communications optional switching functions.

### SUMMARY OF THE INVENTION

In general, this invention describes a novel approach to reduce installation complexity associated with cabling in a modular data communications system. The customer is not required to move wires attached to devices as new communications functions are added. Another feature of this invention is that the cost to combine data from the various modules in a modular communications system is deferred until the additional modules are purchased.

In one preferred embodiment, the invention comprises a modular electronic communications system including a base unit that preferably, but not necessarily, does not include the data combining function, a connection from the base unit to at least one external communications device, and at least one module comprising at least one additional communications feature, wherein the module is capable of being coupled directly to the base unit, and wherein the module further comprises a data combining function for combining information or data from the base unit and the module. In some preferred embodiments the module is capable of functioning independently of the base unit. In other embodiments additional modules may be coupled either to the base unit or to the first module, and the additional modules preferably include data combining functions, however in some embodiments the additional modules will not include a data combining function. In some embodiments the subsequent modules are capable of functioning independently of the base unit.

The invention further comprises a method for adding additional network functions into a network system without requiring changing the physical wiring. A preferred method includes the steps of: (a) obtaining a base data communications unit which preferably does not have a data combiner function; (b) installing the base unit and connecting a communications device to the base unit; (c) obtaining one or more additional data communications functions contained in a first modular unit; and (d) coupling the first modular unit directly to the base unit without altering the existing wiring installed in the above step (b). The method may further include the steps of: (e) obtaining one or more additional data communications functions contained in a second modular unit; and (f) coupling the second modular unit directly to either the base unit or to the first modular unit without altering the existing wiring installed in the above step (b).

### BRIEF DESCRIPTION OF THE DRAWINGS

FIG. 1 (prior art) shows a common home computer cable modem system including a computer and a cable modem.

FIG. 2 (prior art) shows the home computer cable modem system of FIG. 1 after the addition of a module including a second communications function.

FIG. 3 (prior art) shows an internal schematic of the system of FIG. 2.

FIG. 4 shows a home computer cable modem system including a computer and a cable modem similar to the prior art, except that the cable modem is also a base unit.

FIG. 5 Shows the home computer cable modem system after the addition of a module, coupled directly to the base unit.

FIG. 6 shows an internal schematic of one embodiment of the invention including a base unit and one module coupled to the base unit.

FIG. 7 shows an internal schematic of an alternate embodiment of the invention including a base unit and one module coupled to the base unit.

FIG. 8 shows an internal schematic of an alternate embodiment of the invention including a base unit and one module functioning separately form the base unit.

FIG. 9 shows an internal schematic of an alternate embodiment of the invention including a base unit and several modules stacked on the base unit.

### DESCRIPTION OF THE PRFERRED EMBODIMENTS

In general, this invention describes a novel system and method for reducing installation complexity associated with cabling in a modular data communications system. A feature of this invention is that some of the hardware costs associated with combining data from the various modules in a modular communications system are deferred until the additional modules are purchased.

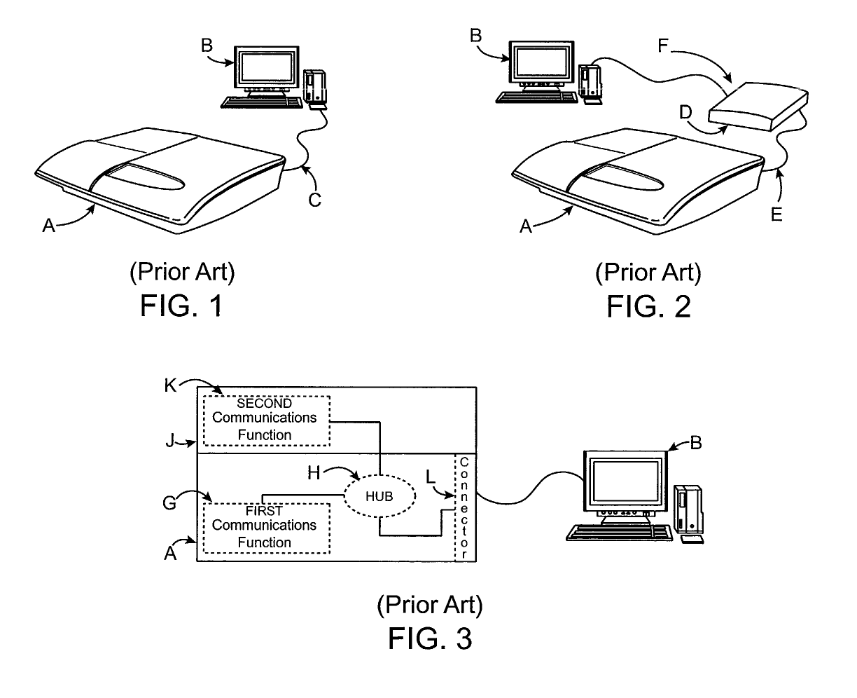

A practical example of the usefulness of this invention is in a home environment in which a customer has purchased a cable modem or an ADSL modem. Over time the customer may add additional computers or require additional network control features such as a router or firewall. An example is seen in FIG. 1 (prior art), wherein a customer initially purchases a base communications function such as cable modem A. The customer plugs his computer B into the modem A using a cable C. If the customer desires to add another communications function, such as router D, the customer must perform the following sequence to migrate to the configuration shown in FIG. 2 (prior art): (a) The cable C from the computer B is removed from modem A. (b) Modem A is connected to router D using cable E. (c) Router D is connected to computer B using cable F. In prior art systems the customer must find a location for the additional component somewhere near the modem. Frequently, the customer must also ensure access to a power-outlet to power the new device.

Prior art modular systems that do not require the customer to disconnect cables exist but these existing systems have internal data combining functions implemented in the base unit. Such preexisting systems are typically more costly because the price includes the cost of equipment that is used in combining data from the various modules. Implementations of the data combining function may be in hardware or software. For example, if a base unit can accept seven modules, it may need a combiner capable of multiplexing data from seven ports and the cost of the base unit reflects this maximum capacity, even if the customer will only use a limited subset of the seven modules. A common example of this kind of modular system is a cable modem which also functions as the base unit, an Ethernet hub or switch using the Ethernet protocol providing the data combiner function, and the wireless access point being a plug-in module. This previously existing configuration is shown schematically in FIG. 3 (prior art), where modem A, which comprises a base unit, contains the desired first communications function G, the data combiner function H, which in this example is an Ethernet hub, and connector L to the external communications devices, such as computer B shown. The plug in module J contains the second communications, Function K, which is in electrical communication with data combiner H in the modem.

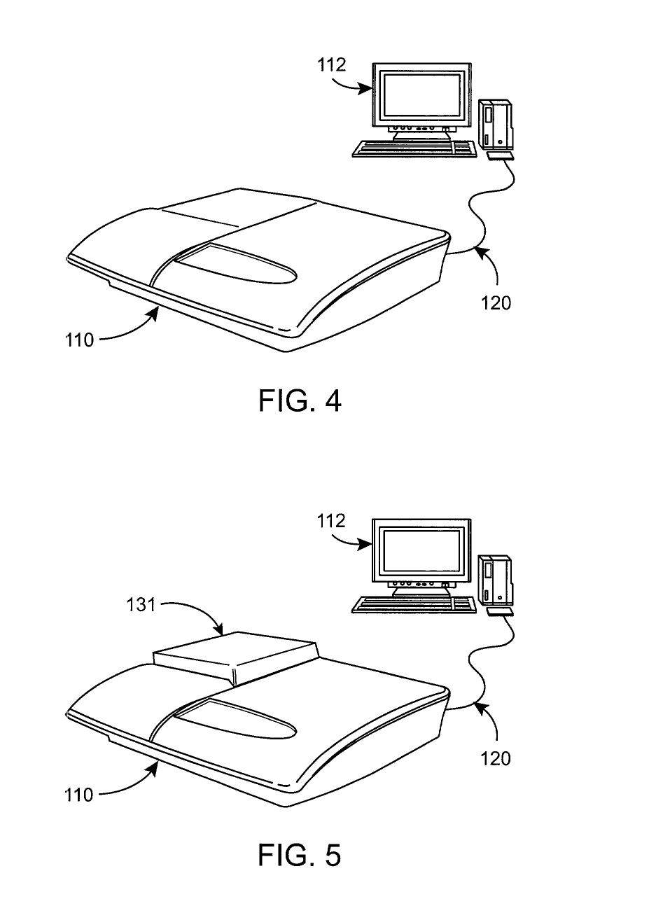

The present invention differs from the prior art in that while the data combiner function is located in the base unit for prior art approaches, it is located in the plug-in module of the present invention. The data combiner performs a data combining function of transferring data packets between the various data links. Example implementations of this function are an Ethernet hub, ATM switch, a router, or a computer that performs this function primarily using software rather than specialized hardware. The distinction between the placement of this function in prior art and the system of the invention is very important and can be seen in FIGS. 4 through 9.

Referring to FIG. 4, a customer buys a modem 110, such as a cable modem or an ADSL modern, and hooks it up to their computer 112 or other device, through cable 120. At some time the customer may choose to add additional computers or may require additional network control features such as a router or firewall, or any other device embodied in a modular form. In the simplest embodiment of the invention, seen in FIG. 5, a module 131 is placed directly onto the modem 110, which acts as a base unit and may hereafter be referred to as base unit 110, and the installation is complete. Unlike preexisting system configurations, in the present invention the cable 120 to the computer 112 is not required to be moved. Thus, using the present invention is much easier than the prior art. The customer simply couples the module 131 to the base unit 110. The customer is not required to find a power outlet because the base unit preferably supplies power to the module, or a clear spot near the base unit 110 on which to set the module 131 because the module is preferably coupled directly to the base unit, or to move the cable 120 connecting to the computer 112 because the data combiner of the module performs the required data combining function.

Furthermore, the system of the invention does not require the presence of a data combiner in the base unit 110, and thus can be manufactured less expensively than preexisting base systems that include a data combiner. In the present invention, the cost of the data combiner is encountered only when a module is purchased. This partitioning of the data combiner function thus allows lower initial cost for the customer and a scaleable cost which is only incurred when (or if) needed. Furthermore, expandability is not limited by a fixed data combiner configuration as is the case where the data combiner is manufactured into a preexisting base system.

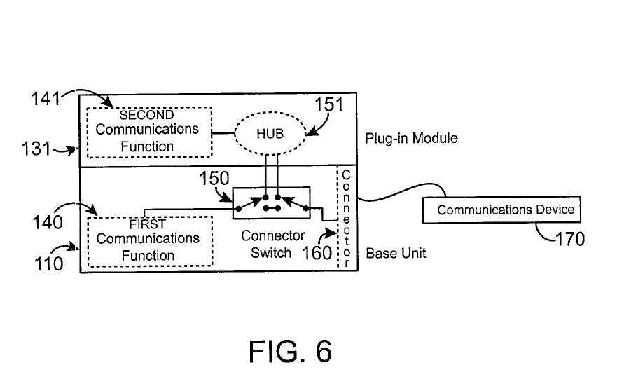

In the present invention, shown schematically in FIG. 6, the base unit 110 contains a desired first communications function 140, a connector 160 in communication with an external communications device 170, and a connector switch 150 to reroute the output of the connector 160 to the data combiner function 151 of the plug-in module 131. The connector 160 maybe any known plug, socket or other communications coupling device, and the communication device 170 may be any known external communication device including a computer or server. The link between the connector 160 and the communications device 170 may use any known network means including various cable and telephone line based systems, and also various wireless communications network systems.

The plug-in module 131 contains a second communications function 141 and the data combiner function 151, which is shown here as a hub. In alternate embodiments the data combiner could be any known software, hardware, or combined software and hardware apparatus, which performs the desired combiner function.

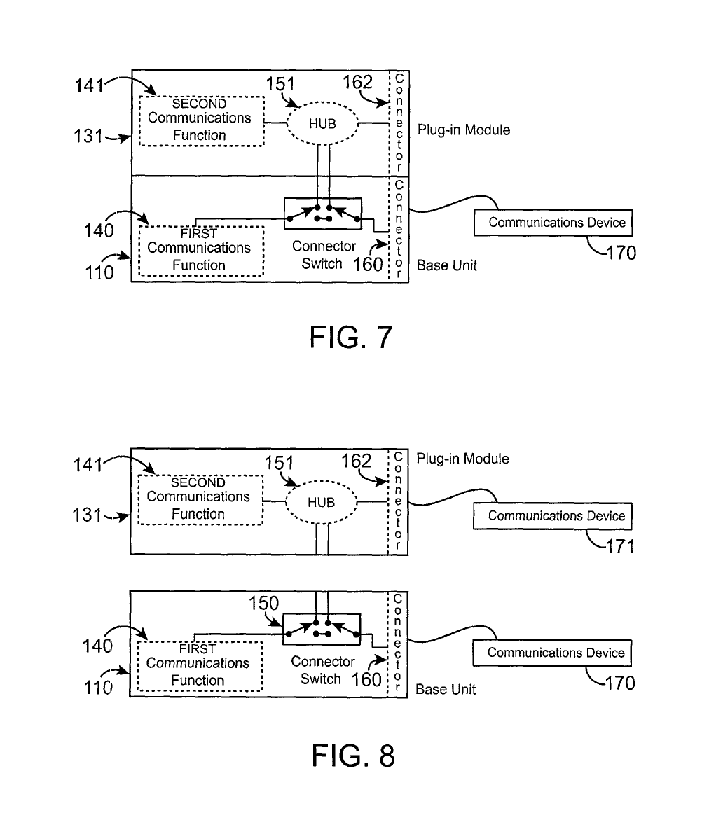

In an alternate embodiment of the invention, shown schematically in FIG. 7, the base unit 1 10 contains the desired first communications function, 140, the connector 160 in communication with an external communications device 170 and a connector switch 150 to reroute the output of the connector 160 when the module 131 is coupled to the base unit 110. The module 131 contains the second communications function 141, the data combiner function 151, and a connector 162 which may not need to be used when connected to the base unit 110.

The purpose of connector 162 is shown in FIG. 8. It is possible that the customer will desire to have the base unit 110 and module 131 operating independently. In this case, the external communications device 170 uses connector 162 to transfer signals from the second communications function 141 directly to a second external communication device 171 without passing the communication first through the base unit 110.

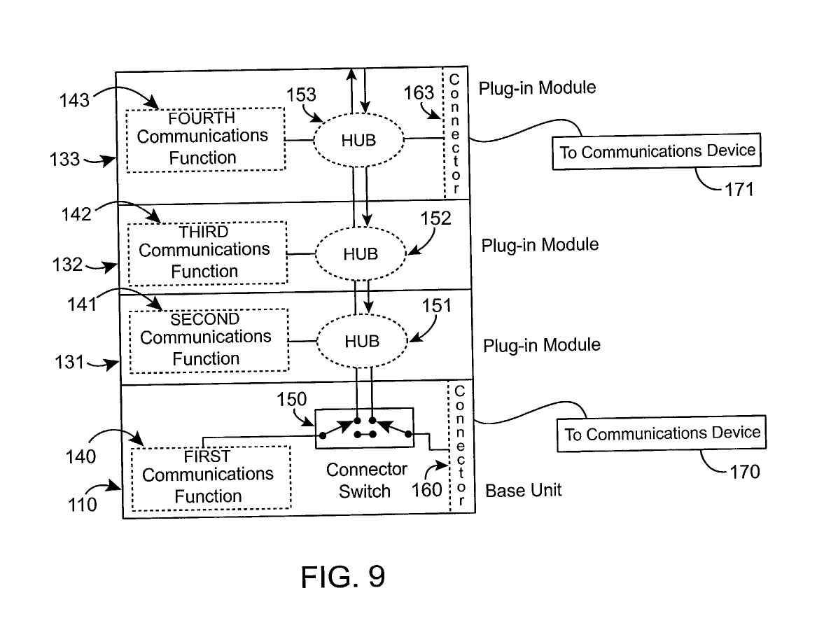

In other embodiments of the invention, as seen in FIG. 9, multiple plug-in modules 131, 132, and 133 may be stacked on the base unit 110. Module 131 is coupled to the base unit 110 as previously discussed. The second module 132 is coupled to the first module 131. Module 132 includes a third communications function 142, and a data combiner 152, which allows data from module 132 to be combined with the data from the base module 110, and also modules 131 and 133. Module 133 includes a fourth communications function 143, and a data combiner 153, which allows data from module 133 to be combined with the data from the base module 110, and also modules 131 and 132. Modules 131 and 132 are shown lacking a connection to an external communications device. Module 133, however, is shown including a connection 163 with an external communications device 171.

In prior systems, the base unit would require at least a five-way data combiner top handle the traffic from the three plug-in modules, communications from the first communication function, and communications from the data from connector 160. And, the cost for the 5-way data combiner would be encountered when purchasing the base unit.

However, in the present invention, the cost of the data combiner function is spread over several of the modules and the user incurs the cost of the data combiner function only when it is actually used. Thus, FIGS. 4 through 9 clearly illustrates the advantage the invention has over preexisting designs with respect to the placement of the data combiner function.

The device of the invention implements the goal of adding additional network functions without requiring the customer to change the physical wiring, preferably using the following method steps: (a) obtaining a base data communications unit which preferably does not have a data combiner function; (b) installing the base unit and connecting a communications device to the base unit; (c) obtaining one or more additional data communications functions contained in a first modular unit; and (d) coupling the first modular unit directly to the base unit without altering the existing wiring installed in the above step (b). The method may further include the steps of: (e) obtaining one or more additional data communications functions contained in a second modular unit; and (f) coupling the second modular unit directly to either the base unit or to the first modular unit without altering the existing wiring installed in the above step (b).

Although exemplary embodiments of the invention have been described in detail above, those skilled in the art will readily appreciate that many additional modifications are possible without departing materially from the novel teachings and advantages of the invention. For example, two port or three port data combiners may be replaced with four or five port data combiners or more than one communications function can be present within a plug-in module.

What is claimed is:

1. A modular electronic communications system comprising:
a base unit,
a connection from said base unit to at least one external communications device,
at least one module comprising at least one additional communications feature, said module capable of being coupled directly to said base unit, said module further comprising a data combining function for combining information from said base unit and said module.

2. The electronic communications system of claim 1, wherein said base unit does not comprise a data combining function and wherein said base unit comprises a switch for routing data to said combining function located in said module.

3. The electronic communications system of claim 1, wherein said base unit comprises a data combining function.

4. The electronic communications system of claim 1, wherein said module is capable of operating independently of said base unit.

5. The electronic communications system of claim 1, further comprising a second module coupled directly to said first module.

6. The electronic communications system of claim 5, wherein said second module is capable of operating independently of said base unit.

7. The electronic communications system of claim 3, wherein said second module further comprises a data combining function.

8. The electronic communications system of claim 3, wherein the said second module does not comprise a data combining function.

9. A modular electronic communications system comprising:
a base unit comprising at least a first communication function,
a connection from said base unit to at least one external communications device, at least one module comprising at least a second communications function, said module being coupled directly to said base unit,
a data combining function, located in said module, for combining data from at least three data sources, said data sources comprising said second communication function, said first communication function, and said external communications device,
a switch located in said base unit for switching said connection of said external communications device between said combining function located in said module, and said first communication function.

10. The modular electronic communications system of claim 9, further comprising a second module.

11. The modular electronic communications system of claim 9, further comprising a second module positioned remotely from said base unit.

12. The modular electronic communications system of claim 10, wherein said second module is coupled to said base unit base unit.

13. The modular electronic communications system of claim 10, wherein the said second module further comprises a data combining function.

14. The modular electronic communications system of claim 10, wherein the said second module does not comprise a data combining function.

15. The modular electronic communications system of claim 9, wherein said base unit does not comprise a data combining function.

16. A method for adding additional network functions into a network system while keeping the existing physical wiring connections to an external communications device, the method comprising the steps of:
(a) obtaining a base unit;
(b) installing said base unit and connecting an external communications device to said base unit;
(c) obtaining one or more additional data communications functions contained in a first module; and
(d) coupling said first module directly to said base unit while keeping the existing physical wiring connections to said external communication device in step (b).

17. The method of claim 16 further comprising the step of: (e) obtaining one or more additional data communications functions contained in a second module.

18. The method of claim 17 further comprising the step of: (f) coupling said second module to said base unit while keeping the existing physical wiring connections to said communication device in step (b).

19. The method of claim 17 further comprising the step of: (g) coupling said second module to said first module while keeping the existing physical wiring connections to said communication device in step (b).

20. The method of claim 17 further comprising the step of: (h) coupling a cable between said second module and said base unit.
